(19) United States
(12) Patent Application Publication
(10) Pub. No.: US 2013/0204785 A1
(43) Pub. Date: Aug. 8, 2013

(54) MOBILE MANAGED SERVICE

(71) Applicants: Justin T. Monk, Highlands Ranch, CO (US); Jeffrey J. Motto, Mountain View, CA (US)

(72) Inventors: Justin T. Monk, Highlands Ranch, CO (US); Jeffrey J. Motto, Mountain View, CA (US)

(21) Appl. No.: 13/755,213

(22) Filed: Jan. 31, 2013

Related U.S. Application Data
(60) Provisional application No. 61/593,081, filed on Jan. 31, 2012.

(51) Int. Cl. G06Q 20/32

(52) U.S. Cl. CPC G06Q 20/32
USPC 705/44; 705/39

(57) ABSTRACT

One embodiment of the invention is directed to a method comprising receiving, at a mobile payment system, transaction information from a mobile device operated by an originating user. The method further comprises generating, by the mobile payment system, a transaction request message using the transaction information from the mobile device operated by the originating user and analyzing, by the mobile payment system, the transaction request message to determine a type of the transaction. The method further comprises processing, by the mobile payment system, the transaction based on the type of the transaction, wherein the mobile payment system is configured to integrate at least two of an issuer, acquirer, and payment processing network functional modules.

### CROSS-REFERENCES TO RELATED APPLICATIONS

The present application is a non-provisional application of and claims priority to U.S. Provisional Application No. 61/593,081, filed on Jan. 31, 2012, the entire contents of which are herein incorporated by reference for all purposes.

### BACKGROUND

A typical transaction infrastructure may traditionally comprise a plurality of acquirers operating acquirer computers, a plurality of issuers operating issuer computers, and a payment processing network. The payment processing network may operate as a switch, to switch transactions between the remotely located issuer and acquirer computers. Merchant computers may be connected to the acquirer computers, so that a typical transaction message such as an authorization request message may pass from the merchant computer, to the acquirer computer, to the payment processing network, and then to the issuer computer. Such conventional systems are particularly hardware intensive and require various disparate communication networks to allow them to communicate. This can be problematic as well, because problems in the system may not be easily resolved, since the components of such conventional systems are so widely distributed. In addition, because components in conventional systems are remotely located with respect to each other, there can be a latency in the communications between the components. Lastly, because conventional systems are so hardware intensive, it may be difficult to deploy such conventional systems in developing countries that do not have extensive communication networks and remotely located computers.

Embodiments of the invention provide technical solutions to these and other problems, individually and collectively.

### BRIEF SUMMARY

Embodiments of the invention provide for an integrated payment system, which can integrate a number of components of traditional issuers, acquirers, payment processing networks, and issuers. By integrating such components, the system can operate as a simplified centralized computing platform reducing the chance of failure, decreasing latency, and improving processing function. Also, by integrating such disparate components into one system, the system can also provide better functionality than conventional systems as the components can be more easily tailored to function more efficiently than the conventional payment infrastructure system. Lastly, the integrated system is easier to deploy than conventional systems.

One embodiment of the invention is directed to a method comprising receiving, at a mobile payment system, transaction information from a mobile device operated by an originating user. The method further comprises generating, by the mobile payment system, a transaction request message using the transaction information from the mobile device operated by the originating user and analyzing, by the mobile payment system, the transaction request message to determine a type of the transaction. The method further comprises processing, by the mobile payment system, the transaction based on the type of the transaction, wherein the mobile payment system is configured to integrate at least two of an issuer, acquirer, and payment processing network functional modules.

Another embodiment of the invention is directed to a server computer comprising a processor, and a computer readable medium coupled with the processor. The computer readable medium comprising computer readable program code embodied therein. The computer readable program code adapted to be executed by the processor to receive, at a mobile payment system, transaction information from a mobile device operated by an originating user, generate a transaction request message using the transaction information from the mobile device operated by the originating user, analyze the transaction request message to determine a type of the transaction, and process the transaction based on the type of the transaction, wherein the mobile payment system is configured to integrate at least two of an issuer, acquirer, and payment processing network functional modules.

Another embodiment of the invention is directed to a computer readable medium comprising computer readable program code embodied therein. The computer readable program code adapted to be executed by a processor to receive, at a mobile payment system, transaction information from a mobile device operated by an originating user, generate a transaction request message using the transaction information from the mobile device operated by the originating user, analyze the transaction request message to determine a type of the transaction, and process the transaction based on the type of the transaction, wherein the mobile payment system is configured to integrate at least two of an issuer, acquirer, and payment processing network functional modules.

Another embodiment of the invention is directed to a method comprising: receiving transaction information from a device operated by an originating user though a communication channel, determining that the communication channel is an authorized channel for a financial institution associated with the originating user, generating a transaction request message using the transaction information received from the device operated by the originating user, analyzing the transaction request message to determine a type of the transaction, and routing the transaction request message for transaction processing based on the determination of the type of the transaction.

Another embodiment of the invention is directed to a computer comprising code executable by a processor, for implementing a method comprising: receiving transaction information from a device operated by an originating user though a communication channel; determining that the communication channel is an authorized channel for a financial institution associated with the originating user; generating a transaction request message using the transaction information received from the device operated by the originating user; analyzing the transaction request message to determine a type of the transaction; and routing the transaction request message for transaction processing based on the determination of the type of the transaction.

These and other embodiments of the invention are described in further detail below.

### BRIEF DESCRIPTION OF THE DRAWINGS

FIG. 1 shows a diagram of a system according to an embodiment of the invention.

FIGS. 2A and 2B illustrate a logical application communication flow according to an embodiment of the invention.

FIGS. 3A, 3B, 4A and 4B illustrate components of mobile payment system according to an embodiment of the invention.

FIG. 5 is a flow diagram of a mobile payment process according to an embodiment of the invention.

FIG. 6 shows an exemplary portable consumer device according to embodiments of the invention.

FIG. 7 shows an exemplary computer apparatus according to embodiments of the invention.

### DETAILED DESCRIPTION

A traditional transaction infrastructure in may comprise wired networks that connect merchants to a payment processing network (e.g., VisaNet) via acquirer computers (e.g., a financial institution associated with the merchant). To be connected to such an infrastructure, a merchant must go through an extensive formal process to secure a relationship with an acquirer. This process may include such things as a review of the merchant business financials, background checks, and setting up hardware such as a point of sale (POS) terminal at the merchant store to conduct payment transactions with consumers.

This traditional infrastructure is typically a four party model which includes a merchant, acquirer, payment processing network, and issuer. Payment transactions typically occur by a consumer providing his payment device to a merchant (e.g., swiping his credit card through a reader on the POS terminal or waiving it in front of a reader on the POS terminal, providing his credit card account information online, etc.). The merchant then sends a payment authorization request message to the acquirer through which the merchant has a relationship. The acquirer sends the message to the payment processing network and the payment processing network routes the payment authorization message to the issuer of the consumer's payment device for authorization. The issuer determines whether to authorize the transaction and sends an authorization response message back to the payment processing network indicating whether or not the payment transaction is authorized. The payment processing network sends the authorization response message to the acquirer and the acquirer sends it to the merchant. The merchant may then provide the authorization response to the consumer and the purchase is completed (or denied).

In developing countries this type of infrastructure may not exist. Thus, financial institutions such as banks and Mobile Network Operators (MNOs) may not have the infrastructure or means to be set up as a traditional issuer. Moreover, merchants may include small family businesses such as a fruit cart vendor or the like which would not meet the requirements to form a relationship with an acquirer.

Moreover, conducting payment transactions using mobile devices introduces various technical challenges. One challenge is that the role of the user of the mobile device may change on a transaction by transaction basis. For example, a user may be a consumer in one transaction using his mobile device to make a purchase from a merchant. The same user may be a merchant in the next transaction, selling goods or services to a consumer, using the same mobile device and the same account. Thus, the mobile payment system may need to dynamically determine the role of the user. Moreover, a variety of channels may be used to conduct the transactions (e.g., USSD, HTTP, etc.) and the mobile payment system must be able to provide for the various channels. Furthermore, the mobile payment system can handle both closed loop transactions (transactions between users associated with the same financial institution) and open loop transactions (transactions between users associated with different financial institutions). Thus, the mobile payment system can provide interoperability between closed and open loop systems.

Mobile payments have specific characteristics which pose various additional technical challenges. For example, mobile operators and mobile phone access to payments may create massive communities and very high peaks in activity. Moreover, relatively short response times and high throughput may be required to complete transactions over slower channels such as SMS (short message service) and USSD (unstructured supplementary service data). Also, there is a degree of customization and separation that may be required to manage country and regulatory specific requirements.

Embodiments of the invention solve for these and other technical challenges, individually and collectively.

Embodiments of the invention allow mobile payment transactions between users without having a traditional merchant/acquirer relationship and allows for processing of those transactions without requiring that a financial institution (e.g., bank or MNO) be set up as a traditional issuer. The system may incorporate a number of different services in the form of software modules to manage this process. Services may include settlement, fraud, gateway, authorization, fees, billing and dispute management. The system may comprise software modules for performing these and other functions. For example, a user may need to set up an account such as a mobile wallet account to conduct a transaction as a consumer or a merchant. A user conducting transactions as a merchant or as a merchant party to a transaction does not have to set up a relationship with an acquirer to conduct a transaction. Instead, the mobile payment system includes an acquirer functional module that performs the functions that an acquirer would perform for the merchant. These functions may include moving money back and forth between accounts and creating a daily settlement position for the merchant and making sure the merchant is paid for the transaction.

The mobile payment system may include an issuer functional module to provide the services of an issuer on behalf of a financial institution. This may include providing authorization services for authorizing a transaction. For example, the mobile payment system may authorize transactions (e.g., ensure there is sufficient money to fund the transactions, assess fees, etc.) instead of requiring the financial institution to be set up to do authorizations of a transaction. A payment processing network functional module may include routing of transactions for open loop transactions.

Embodiments of the invention allow either a consumer or merchant to initiate a transaction using a mobile device. The consumer and/or merchant may have a mobile wallet associated with the mobile device. A mobile wallet (also referred to as an “electronic wallet” or “digital wallet”) can store user profile information, payment information, bank account information, and/or the like. A mobile wallet may be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming website's, transferring funds between users, and/or the like.

The mobile payment system may process transactions between the merchant/agent and consumer (e.g., via the merchant/agent's mobile device and the consumer's mobile device). For example, the system may receive transaction information, generate a transaction request message using the transaction information, analyze the transaction information or transaction request message to determine the type of transaction, and process the transaction based on the type of transaction. The mobile payment system is configured to integrate at least two of an issuer, acquirer, and payment processing network functional modules as described above.

For example, the consumer and/or merchant may initiate the transaction by entering transaction information into the mobile device (e.g., the mobile device phone number of the consumer or merchant for the transaction, the amount of money for the transaction, a PIN, etc.). A mobile payment system may generate a transaction request message based on the information received from the consumer or merchant. The mobile payment system determines a type of transaction (e.g., closed loop or open loop transaction) and then processes the transaction accordingly by performing the functions of an acquirer (e.g., settlement and payment to merchant), and an issuer (e.g., transaction authorization) for those financial institutions that are associated with the mobile payment system.

The mobile payment system may also be referred to a managed service payment platform, managed services, mobile money managed services, mobile managed service (MMS) and mobile processing services throughout this application.

The mobile payment system may be used by MNOs and banks to provide services specifically for mobile payments ecosystem enablement. This includes local, closed and open loop processing (for subscribers, agents, mobile merchants) and open loop connectivity to a payment processing network such as VisaNet (for interoperability with payment processing network clients, subscribers and merchants).

Details of embodiments of the invention are provided in further detail below.

Mobile Payment System

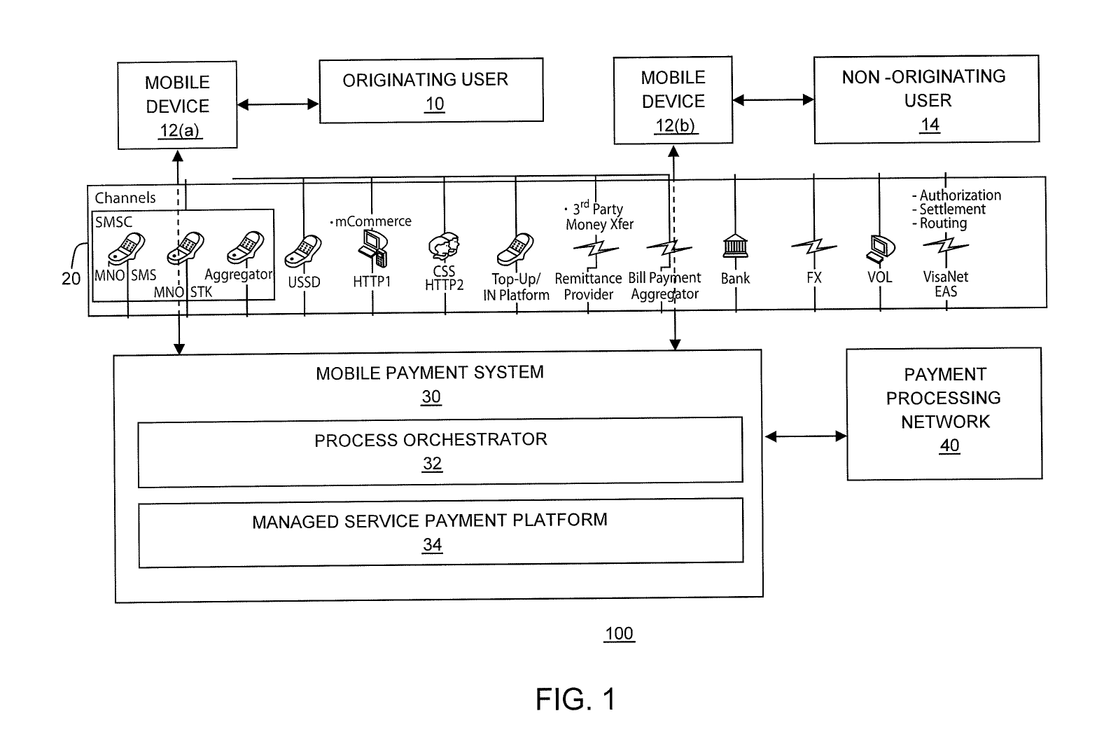

FIG. 1 illustrates a system 100 for conducting financial transactions according to an embodiment of the present invention. The system 100 includes at least one user and at least one mobile device. For example, the system 100 includes an originating user 10 and a non-originating user 14. For simplicity of illustration, one originating user 10 and one non-originating user 14 and two mobile devices are shown (12(a) and 12(b)). It is understood, however, that embodiments of the invention may include multiple users and mobile devices. In addition, some embodiments of the invention may include fewer than all of the components shown in FIG. 1. The components in FIG. 1 can communicate via any suitable communication medium, using any suitable communication protocol.

The originating user 10 and the non-originating user 14 may each be an individual or an organization such as a business that is capable of purchasing goods or services. The originating user 10 and the non-originating user 14 may also be a merchant. The merchant may be an individual or a business that is capable of providing goods or services. The same user may be an originating user 10 in one transaction and a non-originating user 14 in another transaction.

The originating user 10 may operate a mobile device 12(a) and the non-originating user 14 may operate a mobile device 12(b). A mobile device may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. A mobile device may comprise any suitable hardware and software for performing such functions, and may also include multiple devices or components (e.g., when a device has remote access to a network by tethering to another device—i.e. using the other device as a modem—both devices taken together may be considered a single mobile device). A mobile device may also comprise a verification token in the form of, for instance, a secured hardware or software component within the mobile device and/or one or more external components that may be coupled to the mobile device.

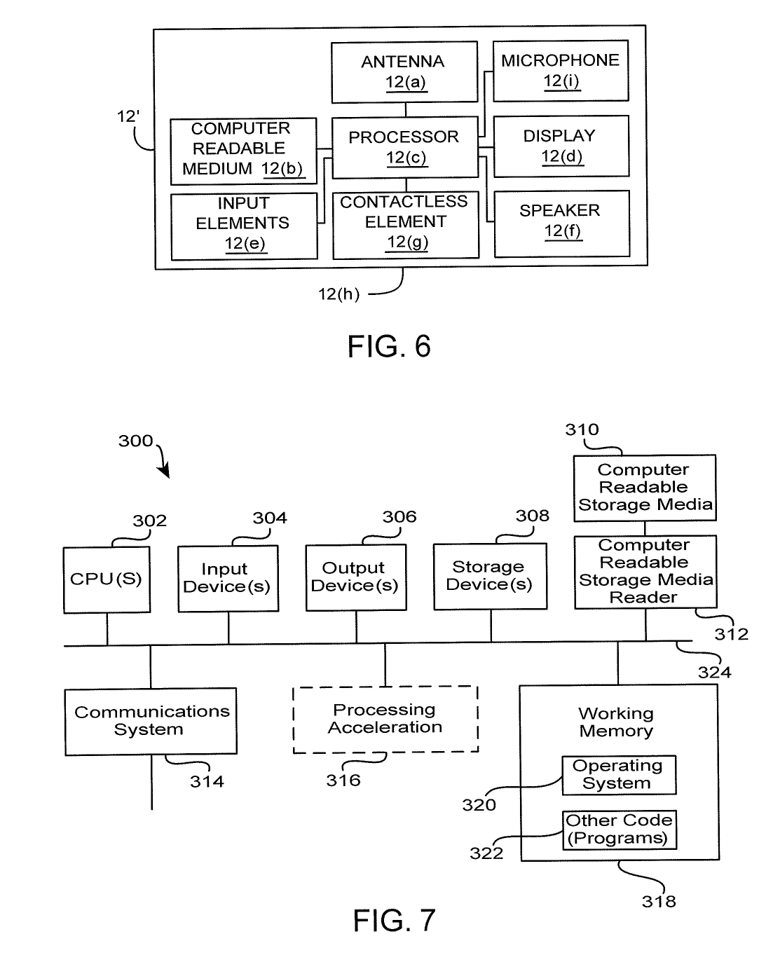

The mobile device 12(a) and 12(b) may be used to initiate the transactions at the merchant or by a merchant with a consumer, and/or receive receipts and/or alerts. FIG. 6 shows a block diagram of a mobile device such as a mobile phone 12′ that may be used in embodiments of the invention. The exemplary wireless mobile phone 12′ may comprise a computer readable medium and a body as shown in FIG. 6. The computer readable medium 12(b) may be present within the body 12(h), or may be detachable from it. The body 12(h) may be in the form a plastic substrate, housing, or other structure. The computer readable medium 12(b) may be in the form of (or may be included in) a memory that stores data (e.g., data relating to issuer specific payment services) and may be in any suitable form including a magnetic stripe, a memory chip, etc. The memory may store information such as financial information, etc. Financial information may include information such as bank account information, a bank identification number (BIN), credit or debit card number information, account balance information, expiration date, user information such as name, date of birth, etc. Any of this information may be transmitted by the mobile phone 12′. For example, any of this financial information may be transmitted by the mobile phone 12′ to a mobile payment system.

In some embodiments, information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The mobile phone 12′ may further include a contactless element 12(g), which is typically implemented in the form of a semiconductor chip (or other data storage element) with an associated wireless transfer (e.g., data transmission) element, such as an antenna. Contactless element 12(g) is associated with (e.g., embedded within) phone 12′ and data or control instructions transmitted via a cellular network may be applied to contactless element 12(g) by means of a contactless element interface (not shown). The contactless element interface functions to permit the exchange of data and/or control instructions between the mobile device circuitry (and hence the cellular network) and an optional contactless element 12(g).

Contactless element 12(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that may be used to exchange data between the mobile phone 12′ and an interrogation device. Thus, the mobile phone 12′ is capable of communicating and transferring data and/or control instructions via both cellular network and near field communications capability.

The mobile phone 12′ may also include a processor 12(c) (e.g., a microprocessor) for processing the functions of the mobile phone 12′ and a display 12(d) to allow a user to see mobile phone numbers and other information and messages. The mobile phone 12′ may further include input elements 12(e) to allow a user to input information into the device, a speaker 12(f) to allow the user to hear voice communication, music, etc., and a microphone 12(i) to allow the user to transmit her voice through the mobile phone 12′. The mobile phone 12′ may also include an antenna 12(a) for wireless data transfer (e.g., data transmission).

Referring again to FIG. 1, an originating user 10 may utilize a mobile device 12(a) to communicate with a mobile payment system 30 and a non-originating user 14 may utilize a mobile device 12(b) to communicate with a mobile payment system 30. As described above, the components in FIG. 1 can communicate via any suitable communication medium, using any suitable communication protocol. Examples of communication channels 20 as shown in FIG. 1 include SMSC (SMS, STX, Aggregator), USSD, HTTP1, CSS HTTP2, Top-Up/IN Platform, remittance provider, bill payment aggregator, bank, FX, VOL, and VisaNet.

SMSC (short message service center) includes various mobile channels. SMS (short message service) is a standard text messaging service. STK is the SIM tookit that allows embedding of menus and authentication into the SIM card itself. An aggregator may be used to support multiple channel or go across multiple MNOs, or SMS and USSD. USSD (unstructured supplementary service data) is another message format for mobile phones.

HTTP1 and HTTP2 may be standard internet channels. HTTP1 may be an m-commerce channel such as a mobile website. CSS HTTP2 may be through a help desk or secure web channel.

The Top-Up/IN platform allows the mobile payment system 30 to send and receive messages indicating that an account has been debited money or airtime to top up the money or air time in the account. A remittance bill provider allows a consumer to send cash to an account (e.g., a mobile wallet) similar to a MoneyGram or Western Union wire transfer. The bill payment aggregator may be an entity that aggregates utility bills (e.g., power, water, gas, TV, etc.). This channel allows the mobile payment system 30 to send a message out to bill payment aggregators to indicate that an individual has paid a bill for a particular account (and thus, send a credit to the utility that the bill has been paid).

The bank integration channel allows the mobile payment system 30 to move money from a user's existing account (e.g., debit account, savings account, etc.) into a mobile wallet account and vice versa. This allows the mobile payment system 30 to move funds from existing off-platform accounts into a mobile wallet and back out again.

FX allows the mobile payment system 30 to receive real time foreign exchange rates for transactions using different currency (e.g., a consumer using Rwandan francs to pay for a purchase at a merchant whose account is in South African rands).

VOL (Visa online) allows the mobile payment system 30 to access the Visa online service. The extended access server (EAS) allows the mobile payment system 30 to access a payment processing network such as VisaNet (e.g., for authorization, settlement, routing of some transactions, etc.).

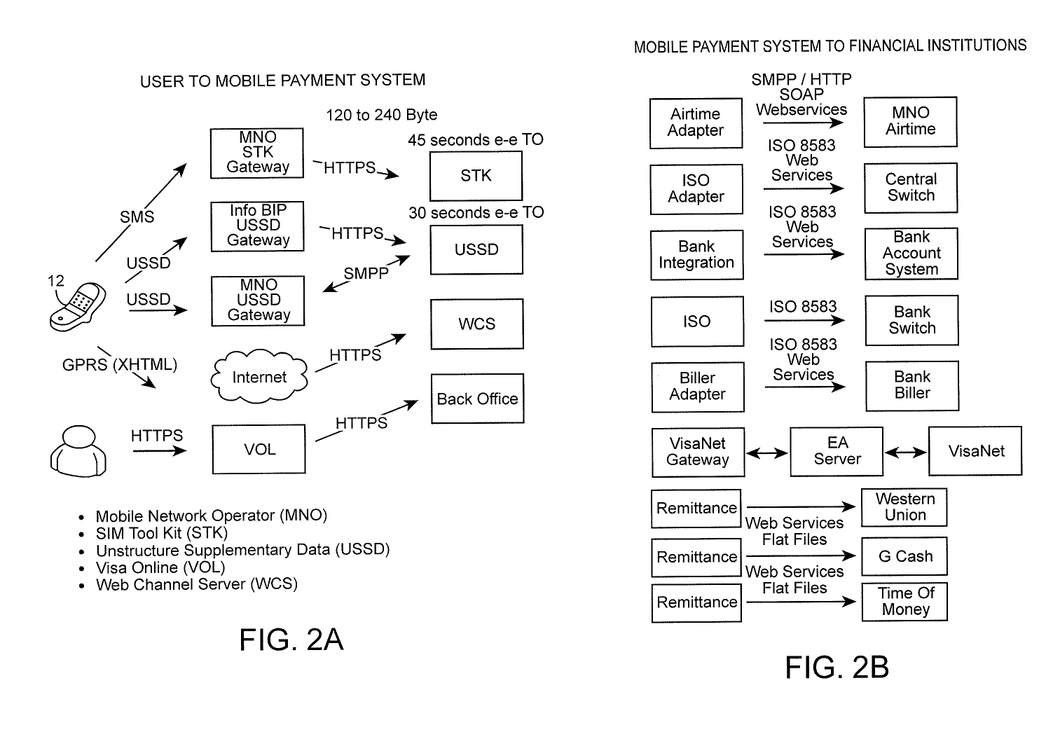

FIGS. 2A and 2B show logical application communication flow according to embodiments of the invention with additional details related to the channels. FIG. 2A shows exemplary communication flow between a mobile device 12 and the mobile payment system 30. As described in further detail above, a variety of channels may be used to communicate between the mobile device 12 and the mobile payment system 30. The mobile device 12 may send information related to a transaction in the form of a message via SMS, USSD, GPRS (XHTML), HTTPS, etc. The message may be received by a particular gateway depending on the communication channel. For example, an SMS message may be received by an MNO STK gateway, a USSD message may be received by a USSD gateway (e.g., Info BIP or MNO USSD gateway), and an HTTPS message may be received by a service such as Visa Online (VOL). The gateway then formats the message and routes it to the mobile payment system 30. The message can be configured to receive the message via a STK, USSD, WCS and Back Office module.

FIG. 2B shows exemplary communication flow between the mobile payment system 30 and various entities. As described above, the mobile payment system 30 may use a variety of channels to communicate with various entities for mobile transactions. For example, the mobile payment system 30 may include an airtime adapter to communication with an MNO via SMPP/HTTP SOAP webservices regarding air time that has been debited to the account associated with a user and/or mobile device. The mobile payment system 30 may include an ISO adapter to communicate to a central switch via ISO 8583 Web Services that may be used to communicate between different systems (e.g., banks) that utilize ISO 8583. The mobile payment system 30 may have a bank integration component to communicate with a bank account system via ISO 8583 web services to move money from a user's bank account to a mobile wallet and vice versa. The mobile payment system 30 may include an ISO component for communicating with a Bank switch via ISO 8583 to exchange transaction and account information (for example) with a bank. The mobile payment system 30 may include a biller adapter to communicate with a bank biller via ISO 8583 web services regarding bill payments. The mobile payment system 30 may include a payment processing network gateway to communicate with payment processing networks such as VisaNet. For example, the system may include a VisaNet gateway coupled with an EA (extended access) server to communicate with VisaNet. The mobile payment system 30 may include various remittance components to communicate with various entities such as money transfer companies to enable sending cash to a user account.

Referring again to FIG. 1, the mobile payment system 30 may include a process orchestrator 32 and a managed service payment platform 34. Each of the process orchestrator 32, the managed service payment platform 34, as well as the mobile payment system 30 may comprise a computer comprising a processor, and a computer readable medium coupled to the processor comprising code configured to implement the methods described herein. The mobile payment system 30 may be configured to integrate at least two of an issuer, acquirer, and payment processing network functional modules. An exemplary issuer functional module may enable authorizing services for authorizing a transaction. This may include determining whether to authorize a transaction (e.g., whether there is sufficient money in the account to fund the transaction) and assessing fees for the transaction. An exemplary acquirer functional module may enable moving money back and forth between accounts and creating a daily settlement position for the merchant and making sure the merchant is paid for the transaction. An exemplary payment processing functional module may enable routing of transactions for open loop transactions.

The mobile payment system 30 may include one or more server computers (e.g., central server) which may have computer readable medium comprising code for performing functions that a payment processing network performs. A “server computer” or “server” is typically a powerful computer or cluster of computers. For example, the server computer may be a large mainframe, a minicomputer cluster, or a group of servers functioning as a unit. In one example, the server computer may be a database server coupled to a Web server. The mobile payment system 30 may use any suitable wired or wireless network, including the Internet. One or more databases may be operatively coupled to the server computer.

The process orchestrator 32 may receive incoming messages and determine where to route the messages, as explained in further detail below.

The managed service payment platform 34 may handle the management and processing of transactions on behalf of financial institutions, MNOs or other entities (hereinafter referred to generally as “financial institutions”) in the mobile payment system 30. For example, the Bank of Kigali may be part of the mobile payment system 30. The Bank of Kigali may have a defined program in the system that is configured to have particular commissions, fees, limits, thresholds, channels, etc. to define how their mobile money program should operate. The managed service payment platform 34 may manage all balances, fees and commissions for the financial institutions' mobile wallet programs. Thus, the mobile payment system 30 may process transactions on behalf of the financial institutions, unlike a traditional transaction infrastructure where each issuer is responsible for authorization and related services for processing a transaction.

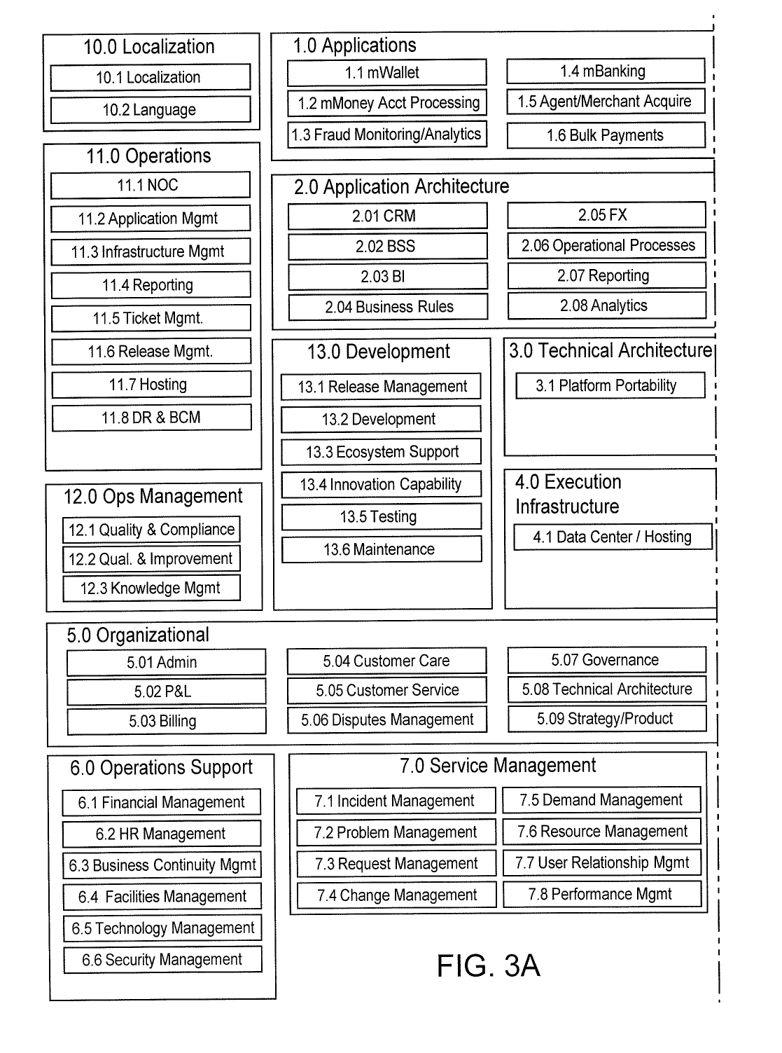

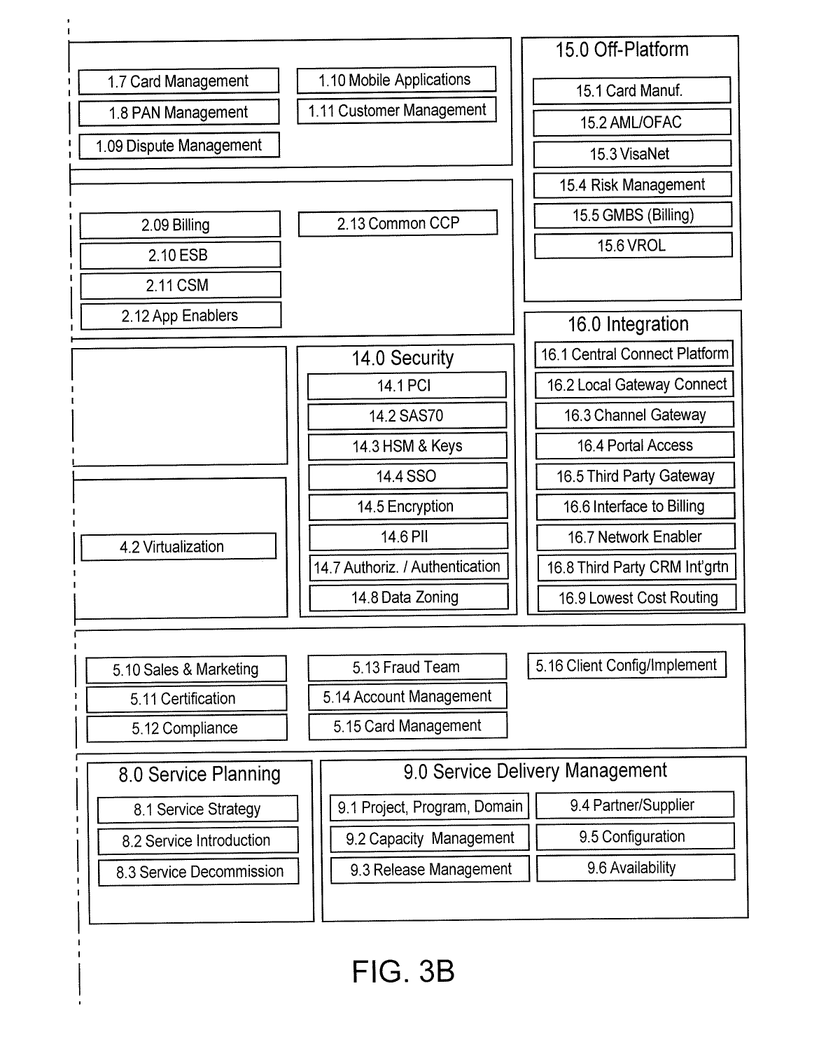

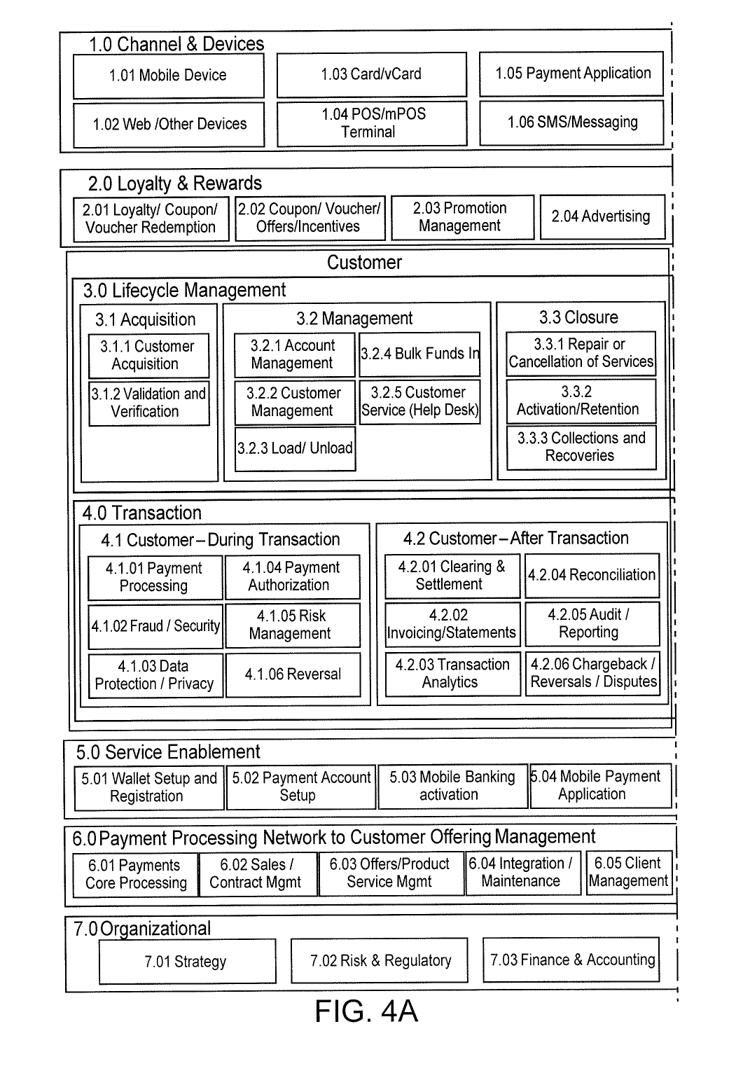

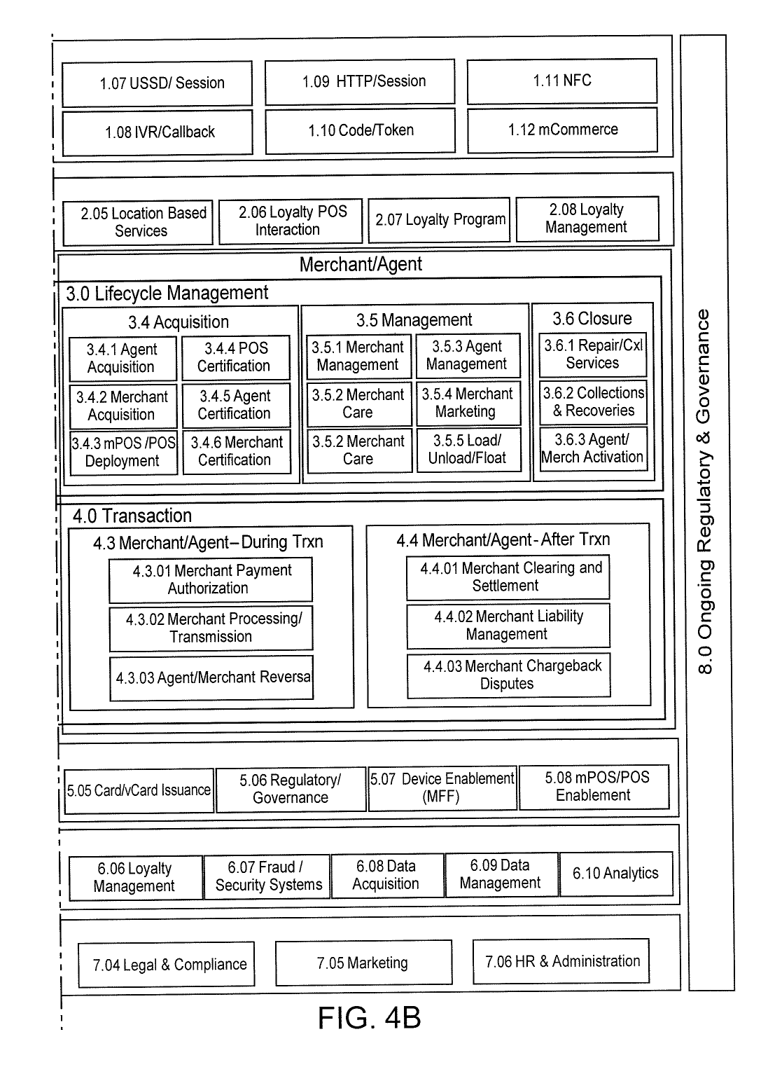

FIGS. 3A, 3B, 4A and 4B show exemplary components that may reside in the managed service payment platform 34 of the mobile payment system 30 and are discussed in detail below.

Referring back to FIG. 1, the mobile payment system 30 may be in operative communication with a payment processing network 40. The payment processing network 40 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network may include one or more server computers (e.g., central server) which may have computer readable medium comprising code for performing functions that a payment processing network performs. A “server computer” or “server” is typically a powerful computer or cluster of computers. For example, the server computer may be a large mainframe, a minicomputer cluster, or a group of servers functioning as a unit. In one example, the server computer may be a database server coupled to a Web server. The payment processing network may use any suitable wired or wireless network, including the Internet. One or more databases may be operatively coupled to the server computer.

Mobile Payment System Transactions

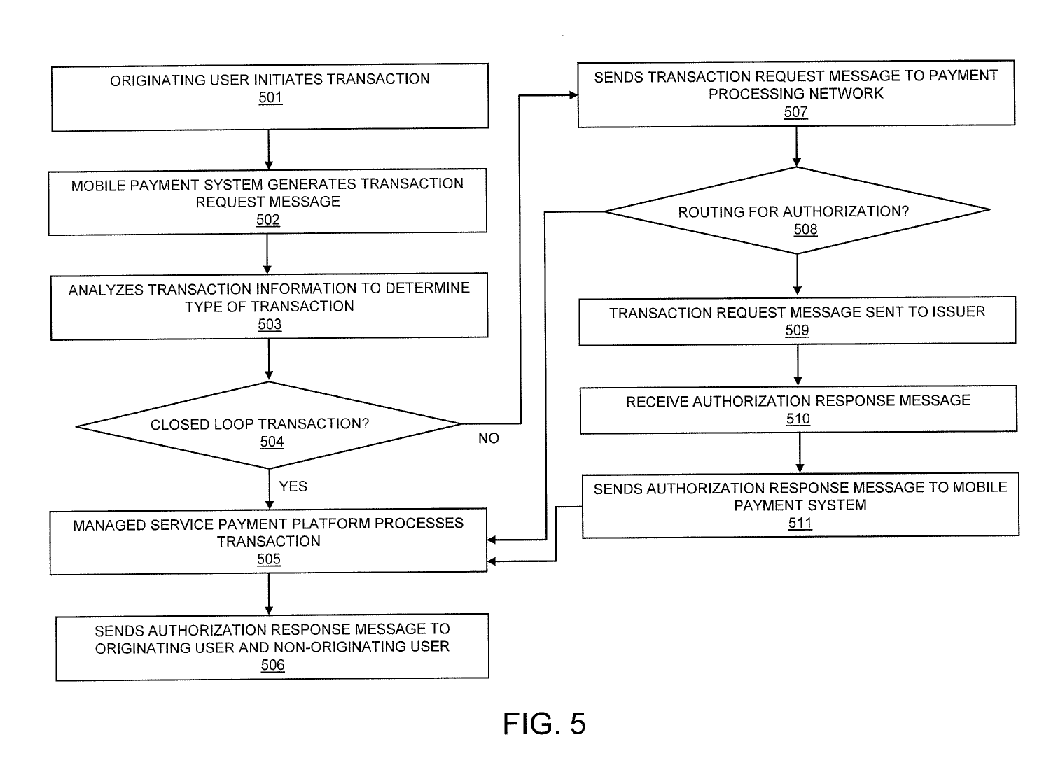

FIG. 5 shows a flowchart including a general method according to an embodiment of the invention. This method can be described with reference to the block diagram in FIG. 1.

In a typical transaction a consumer may use a mobile device to make a payment transaction. The consumer may have a mobile device such as a mobile phone associated with a mobile wallet. For example, the consumer may go to a fruit cart on the corner near his home to purchase apples. Either the consumer or the merchant at the fruit cart may initiate the transaction. For example, the consumer may be the originating user 10 and may initiate the transaction using his mobile device 12(a) (step 501), and the merchant of the fruit cart may be the non-originating user 14 and may operate a mobile device 12(b). In the alternative the merchant of the fruit cart may be the originating user 10 and may initiate the transaction using his mobile device 12(a) (step 501), and the consumer may be the non-originating user 14 and may operate a mobile device 12(b).

The originating user 10 may initiate the transaction (step 501) by sending a message (e.g., SMS, email, etc.), opening a payment application, sending a short code, etc. For example, the originating user 10 may enter a short code into his mobile device such as *501# to initiate the transaction. A message may be sent to the process orchestrator 32 of the mobile payment system 30 indicating that the originating user 10 desires to initiate a transaction. After entering the short code, a menu may appear on the originating user's 10 mobile device 12(a) that requests information about the transaction. Exemplary information requested may include a destination account or phone number (e.g., the mobile device phone number of the merchant for the fruit cart), the amount of money to be paid, and/or a PIN or password for authentication. For example, the originating user 10 may enter “5551234567” for a destination mobile phone number, “$1000 francs” for the amount of money to be paid, and “1234” for a PIN. The originating user may also be asked for his mobile phone number or account number or the mobile payment system 30 may determine this information automatically from the information received by the originating user 10.

The information may be requested all at once and sent to the mobile payment system 30 or may be requested one or two items at a time depending on the channel/communication means used by the originating user 10. For example, the originating user 10 may send the requested information via a text message (e.g., SMS) which has a limit to the number of characters that can be sent in one message. Thus several messages may be sent to convey all of the information to the mobile payment system 30. The information may also be requested one item at a time to allow for ease of use for the user. This may be particularly important for users that may not read very well.

The requested transaction information is sent to the mobile payment system 30. The process orchestrator 32 receives the transaction information. The process orchestrator 32 may start caching the information as it receives it from the originating user 10 to generate a transaction request message. The process orchestrator 32 may also request additional information from the originating user 10 by sending an information request message to the mobile device 12(a) operated by the originating user 10.

The process orchestrator 32 determines whether the originating user 10 is an authorized user of the system. For example, the process orchestrator 32 may determine that the mobile phone number associated with the mobile device is a mobile number associated with the mobile payment system 30. The process orchestrator may also verify that the PIN is correct to authenticate the originating user 10. If the originating user 10 is not an authorized user, the transaction may be denied. The process orchestrator 32 may send a message to the mobile device 12(a) operated by the originating user 10 indicating that the transaction has been denied. The process orchestrator 32 may also send a message to the mobile device 12(b) operated by the non-originating user 14 indicating that the transaction has been denied.

If the originating user 10 is a merchant, the mobile payment system 30 may also need to authenticate the consumer non-originating user 14 for the transaction since the funds for the transaction will be coming from an account associated with the consumer non-originating user 14. In this case, the process orchestrator 32 may send an authentication message to the mobile device 12(b) operated by the consumer non-originating user 14 requesting authentication information from the consumer non-originating user 14. For example, the message may ask the consumer to enter a PIN and/or may ask the consumer non-originating user 14 to confirm that he wants to proceed with the transaction.

Once the consumer non-originating user 14 enters the authentication information and/or indicates whether or not he wishes to proceed with the transaction, the authentication information may be sent by the mobile device 12(b) to the process orchestrator 32. The process orchestrator 32 may verify the authentication information (e.g., PIN) is correct to authenticate the consumer non-originating user 14, and/or determine if the consumer non-originating user 14 wishes to proceed with the transaction. If the process orchestrator 32 determines that the authentication information is not correct, and/or the consumer non-originating user 14 does not wish to proceed with the transaction, the process orchestrator 32 may send a message to the mobile device 12(a) operated by the originating user 10 indicating that the transaction has been denied. The process orchestrator 32 may also send a message to the mobile device 12(b) operated by the non-originating user 14 indicating that the transaction has been denied.

If the process orchestrator 32 determines that the authentication information is correct, and/or the consumer non-originating user 14 does wish to proceed with the transaction, the process orchestrator 32 will proceed with processing the transaction.

The transaction information may be sent using a variety of channels 20, as explained in further detail above. The process orchestrator 32 may determine whether the channel is an authorized channel for the financial institution associated with the originating user. For example, the financial institution (e.g., Bank of Kenya) may be configured to only accept a certain amount of predefined channels (e.g., only USSD). This may be for security purposes so that if transaction information/requests are received from non-accepted channels, the system knows that it is not a legitimate channel and can deny the transaction. The process orchestrator 32 may access the mobile program for the Bank of Kenya and check which channels are authorized channels for the Bank of Kenya. Thus, the orchestrator 32 may automatically determine which channels are suitable for use with a particular acquirer or issuer.

If the process orchestrator 32 determines that the channel used to initiate the transaction is not an authorized channel, the transaction may be denied. The process orchestrator 32 may send a message to the mobile device 12(a) operated by the originating user 10 indicating that the transaction has been denied. The process orchestrator 32 may also send a message to the mobile device 12(b) operated by the non-originating user 14 indicating that the transaction has been denied.

If the originating user 10 is an authorized user (using an authorized channel), the process orchestrator 32 may generate a transaction request message based on the information sent by the originating user 10 (step 502). The process orchestrator 32 may also analyze the transaction information to determine a type of the transaction (step 503). Different transaction processing may occur based on the type of transaction. For example, the process orchestrator 32 may determine whether the type of transaction may be a closed loop or an open loop transaction (step 504).

A closed loop transaction may be where both accounts for both parties to the transaction are associated with the same financial institution. For example, the financial institution for an account associated with the originating user 10 may be the Bank of Kenya and the financial institution for an account associated with the non-originating user 14 may also be the Bank of Kenya.

An open loop transaction may be where the account for each party is associated with a different financial institution. For example, the financial institution for an account associated with the originating user 10 may be the Bank of Kenya and the financial institution for an account associated with the non-originating user 14 may be the Bank of Kigali.

To determine the account associated with the originating user 10 the process orchestrator 32 may take the originating user's 10 mobile phone number and convert it into a primary account number (PAN). To determine the account associated with the non-originating user 14 the process orchestrator 32 may take the non-originating user's 14 mobile phone number and convert it into a primary account number (PAN). A PAN may include a BIN (bank identification number). The process orchestrator 32 may compare the BIN for the account associated with the originating user 10 with the BIN for the account associated with the non-originating user 14 to determine whether or not they are associated with the same financial institution (e.g., have the same or different BINs).

If the type of the transaction is a closed loop transaction, the managed service payment platform 34 processes the transaction (step 505). For example, the managed service payment platform 34 will determine an account to be used to fund the transaction based on information included in the transaction request message. The managed service platform 34 will look up the account from which the funds will be paid to and determine whether there are sufficient funds in the account to cover the transaction. The managed service payment platform 34 may also determine whether there are any fees associated with the transaction. For example, the managed service platform 34 may look at a fee table for the transaction and based on the mobile program set up with the financial institution, determine if fees are associated with the transaction and if fees are applicable, and which party pays for the fees (e.g., originating user 10, non-originating user 14, both, etc.). If fees are applicable, the fees will be deducted from the appropriate account.

If there are sufficient funds in the account to cover the transaction, the managed service payment platform 34 debits the account the amount of the transaction and credits the account that is to receive the funds, the amount of the transaction. If there are any fees associated with the transaction, the accounts may be debited accordingly.

The process orchestrator 32 may send a message to the mobile device 12(a) operated by the originating user 10 indicating that the transaction has been approved and is complete (step 506). The process orchestrator 32 may also send a message to the mobile device 12(b) operated by the non-originating user 14 indicating that the transaction has been approved and is complete (step 506). The message sent to the originating user 10 and the non-originating user 14 may include an indication of any fees charged for the transaction.

If the type of transaction is an open loop transaction, the process orchestrator 32 may send the transaction request message to a payment processing network 40 (step 507). The payment processing network 40 may then analyze the transaction request message to determine where to route the transaction request message for authorization (step 508). For example, the payment processing network 40 may look at the BIN (bank identification number) in the transaction request message to determine the issuing entity for the account. If the payment processing network 40 determines that the mobile payment system 30 is the processing entity for that particular issuing entity, then the payment processing network 40 will send the transaction request message back to the mobile payment system 30.

The process orchestrator 32 receives the transaction request message from the payment processing network 40 and the managed service payment platform 34 processes the transaction (step 505). For example, the managed service payment platform 34 will look up the account from which the funds will be paid to and determine whether there are sufficient funds in the account to cover the transaction. The managed service payment platform 34 may also determine whether there are any fees associated with the transaction. If there are sufficient funds in the account to cover the transaction, the managed service payment platform 34 debits the account the amount of the transaction and credits the account that is to receive the funds, the amount of the transaction. If there are any fees associated with the transaction, the accounts may be debited accordingly.

The process orchestrator 32 may send a message to the mobile device 12(a) operated by the originating user 10 indicating that the transaction has been approved and is complete (step 506). The process orchestrator 32 may also send a message to the mobile device 12(b) operated by the non-originating user 14 indicating that the transaction has been approved and is complete (step 506). The message sent to the originating user 10 and the non-originating user 14 may include an indication of any fees charged for the transaction. For example, the originating user may get a message saying “Transaction approved, 1,000 francs debited from your account” and the non-originating user may get a message saying “Transaction approved, 1,000 francs credited to your account.”

If the payment processing network 40 determines that the issuing entity is not associated with the mobile payment system 30, then the payment processing network 40 will send the transaction request message to the issuing entity (not shown) for authorization (step 509). The issuing entity will determine whether or not to authorize the transaction (e.g., whether there are sufficient funds to cover the transaction) and send an authorization response message back to the payment processing network 40. The payment processing network 40 will receive the authorization response message (step 510). The payment processing network 40 may send the authorization message back to the mobile payment system 30 (step 511) via the process orchestrator 30. The process orchestrator 30 may send an authorization response message back to the payment processing network 40 to indicate that the transaction has been completed.

The process orchestrator 32 may send a message to the mobile device 12(a) operated by the originating user 10 indicating that the transaction has been approved and is complete (step 506) or has been denied. The process orchestrator 32 may also send a message to the mobile device 12(b) operated by the non-originating user 14 indicating that the transaction has been approved and is complete (step 506) or has been denied. The message sent to the originating user 10 and the non-originating user 14 may include an indication of any fees charged for the transaction.

Managed Service Payment Platform

The managed service payment platform 34 may comprise a number of components as shown in FIGS. 3A, 3B, 4A and 4B. FIGS. 3A and 3B show[s] a managed service component model for the managed service payment platform 34 and FIGS. 4A and 4B show[s] a MMS service offering model for the managed service payment platform 34.

Software modules capable of performing the functions described in FIGS. 3A and 3B may be present in the managed service payment platform. It is noted that embodiments of the invention, at least one, two, three, four, etc. functional modules of at least two or at least three of the acquirer, issuer, payment processing network, and merchant functional modules may be present in the platform 34. In some embodiments, there can be at least 5 functional modules of each of the acquirers, issuers, payment processing network, and merchant are present in the managed service payment platform 34. As shown in FIGS. 3A, 3B, 4A and 4B, the resulting platform combines the functionality of these entities in a single platform, thus providing for more efficient and effective operation as compared with conventional systems. Such modules may be combined in any suitable manner in embodiments of the invention.

In some embodiments, issuer modules may be combined with acquirer modules in a single platform. In such cases, the data transfer and data manipulation can occur between the modules designated by those issuers and acquirers within the same platform. The data transfer is faster than conventional system whereby communication between issuer modules and acquirer modules occurs in a remote fashion. Further, updates to those modules and the subsequent integration that needs to occur between acquirer and issuer modules is less burdensome than in conventional systems, since all modules reside in a single platform.

1.0 Applications

Module 1.0 outlines applications that may be available on the managed payment platform. The mWallet component 1.1 supports common operations related to a mobile wallet platform. The mWallet component allows customers to retrieve their wallet balance, transfer money to other accounts, and load/unload cash from the service. MNOs and Banks may have the ability to perform limited branding of the mobile wallet platform.

The mMoney account processing component 1.2 provides core processing for open and closed-loop prepaid accounts on behalf of issuers and MNOs. This includes card management functionality, authorization and settlement, enrollment and issuance, and funding and fee management.

The fraud monitoring/analytics component 1.3 provides fraud management and detection services. This may include portfolio analytics, rules setup and testing, fraud case management and investigation, local authority reporting, fraud monitoring, and fraud mitigation.

The mBanking component 1.4 provides a mobile banking platform, connecting virtual wallets with banks.

The Agent/Merchant Acquire component 1.5 provides an application to handle the process of adding new merchants and agents to the service. It may provide a toolset for on-boarding of agents and merchants into the platform.

The Bulk Payments component 1.6 provides a bulk payment tool to allow for large-scale distribution of payments. This feature may be used by commercial parties and governments to pay multiple cardholders via a unified format (e.g., a single agreed-to format). This may include management of bulk payment files, processing, payment to government payment system, and support for various file formats to allow for large-scale distribution of payments. This component may also provide automation of these processes (e.g., for simple corporate load on the managed service (e.g., entry level payroll)).

The Card Management component 1.7 may provide plastics, creation of card embossing, personalization (e.g., mag-stripe and EMV), fulfillment, inventory management, etc. This allows for management of a blacklist or hotlist of lost and stolen cards. This may include functionality for issuing and allocating physical cards to users and accounts. Physical distribution of cards that correspond to a mobile wallet may be an optional MMS service.

Card Management may further include acquisition of a primary account number (PAN) list, sharing it with a manufacturer, manufacturing a set of cards to a specification, receiving the cards, allocating them to an account, and mailing them to the consumer. Card Management may further include card activation and tracking use on the system, and card deactivation and removal from the system. Further functionality may include management of serial and card number tracking, inventory management, auto-replenishment, allocation, or activation management.

The PAN (primary account number) Management component 1.8 may include management and mapping of account numbers of open-loop, prepaid PANs, linking of Virtual PANs, one-time-use PANs, companion plastic, phone number, de-linking, and lost or stolen replacements.

The dispute Management component 1.09 may provide payment dispute management and resolution for transactions.

The Mobile Applications component 1.10 may include Simple SIM Toolkit, USSD-based applications, and full applications (e.g., iPhone, Blackberry, Android, etc. applications). The service may provide a mobile application to handle the day-to-day management of a mobile wallet, functions to initiate and authorize transactions, and perform PIN maintenance.

The Customer Management component 1.11 may include direct management of customer information on the platform via an agent or merchant CRM, or direct management of information on the platform.

2.0 Application Architecture

Module 2.0 outlines an application architecture that may be available on the managed service payment platform. The CRM (customer relationship management) component 2.01 may include connectivity between third party systems, movement of data to and from third party CRM, and CRM synchronization between external and any internal platform CRM.

The BSS (Business Support Services) component 2.02 may provide tools for billing, rating, charging, and high-level functions.

The BI (business intelligence) component 2.03 provides tools for the collection, collation, and aggregation of data for subsequent analytics. It provides tools for display, dashboards, graphs and actual analytical capabilities.

The Business Rules service component 2.04 may provide a rules engine to handle the regulatory and compliance requirements for a mobile wallet, as well as necessary rules for fee structures and other billing-related items.

The FX (foreign exchange) component 2.05 provides foreign currency exchange management and rate lookup.

The Operational Processes service component 2.06 may provide a framework for error handling, logging, and monitoring. This information may be used in compiling service metrics.

The Reporting component 2.07 may provide for several types of reporting. Exemplary reporting may include customer/subscriber activity, financial activity (e.g., standard activity, inactive accounts, account transaction history, compliance, recon and settlement), operations (e.g., for measuring the system responsiveness and other operational metrics).

The Analytics component 2.08 may provide analysis services in several forms, including transaction analysis for risk and fraud detection and monitoring, and overall statistics for operational reporting.

The billing service component 2.09 may produce billing reports to allow for monthly billing to the MNO or Issuer and/or incorporate integration into other systems.

The ESB (enterprise service bus) service component 2.10 may support routing and asynchronous messaging between the platform and other supporting applications.

The CSM component 2.11 may provide the routing and functionality to support the association of multiple service offerings with a single individual on the service. The component may associate an MSISDN (Mobile Subscriber Integrated Services Digital Network-Number) with a PAN for routing.

The App Enablers component 2.12 may define a common set of message processing functions. For example, it may standardize the APIs for functions such as HSM, bulk message sending, job scheduling, file transfer, and LDAP (lightweight directory access protocol).

The Common CCP (Common Connection Platform) component 2.13 may provide connections in and out of the service and provide pass-through functionality to functions such as analytics, reporting, and billing. The CCP may facilitate the use of services to allow interoperability between MNO's. The CCP may also provide PAN lookup and switching and routing.

3.0 Technical Architecture

The Platform Portability component 3.1 provides the ability of the MMS service to be ported and moved to a new country.

4.0 Execution Infrastructure

The Data Center/Hosting component 4.1 allows for the outsourcing of the hosting of the EE platform to a Managed Service Data Center (e.g., the Visa Managed Service Data Center). In-country regulations may dictate special payment processing restrictions. For example, some countries require in-country processing and/or data storage, while others require that these processes be housed outside of the United States (to avoid AML/OFAC privacy concerns).

The Virtualization component 4.2 may support the ability to run on virtualized hardware to allow a single physical server to offer many instances of the software stack.

KPI (key performance indicator) Monitoring may use performance indicators (e.g., SLA, TPS, etc.) to track transactional analytics, performance metrics, etc. These metrics may be utilized for pricing, rate cards and volumetrics.

5.0 Organizational

The P&L (profit and loss) component 5.02 tracks the performance metrics of the service. Information rolls down to pricing, rate cards, supplier management, and volumetrics.

The Billing component 5.03 establishes a billing process and integration with other systems (e.g., Visa global member billing solutions (GMBS)). This component may set up the billing process for the managed service, identifying who, what, and how to bill for services.

The Customer Care component 5.04 may support end-user customers as part of a product and card lifecycle. The component may proactively communicate new service features and value-adds to customers.

The Customer Service component 5.05 may include an API for a web portal, a customer service website, USSD support, tools enabling MNOs to provide Level I support, and agent customer service. This component may include a customer service application that may allow clients to provide Level I customer service in-house. The mobile money managed service may provide Level II/III customer service that includes technical issues, detailed transaction disputes and research.

Embodiments of the invention allow for customer service level 1 which may provide a first line support for account holders to resolve basic issues including balance, reporting lost or stolen devices, disputes or chargebacks, last 5 transactions, p2p and billpay. Embodiments of the invention may provide IVR/VRU (interactive voice response/voice response unit) which may include automated voice response unit that may be provisioned by the Issuer or MNO using web service calls provided by the Platform. Embodiments of the invention may provide KYA/KYC (Know Your Agent/Know Your Customer) compliance by providing agent and consumer data authentication with an external source to comply with local KYA/KYC regulations.

Embodiments of the invention may provide a standard customer care website that cardholders can access for basic customer service functions including balance, transaction history, person to person (P2P), Billpay, reporting lost or stolen cards or devices, and additional information on chargebacks and disputes, and frequently asked questions (FAQ). The website may be branded with the Issuer/MNO's brand. Embodiments of the invention may provide a customer service USSD to support USSD service as the basic service offering for communication between the mobile device and the Platform. Services may include Lock/Unlock PAN, Cash-in, Cash-out, P2P, Billpay, Balance check, and Mini-statement. Services may be provided to manage the integration with a local/global USSD aggregator. Embodiments of the invention may provide agent customer service by providing tools to manage the agent network including agent on-boarding, authentication, management and settlement. The application for an agent includes enrollment, cash-in and cash-out.

The Disputes Management component 5.06 may provide customer call processing for disputes and resolution between parties.

The Governance component 5.07 may define the governing body for the managed service.

The Technical Architecture component asset 5.08 may define the development of documented technical architecture and roadmap.

The Strategy/Product component 5.09 may define the service and product needs for the marketplace.

The Sales & Marketing component 5.10 may provide approach, collateral, and go-to-market activity to support the service.

The Certification component 5.11 may provide certification (informal or formal) service requirements.

The Compliance component 5.12 may ensure that the platform complies with best practices and guidelines.

The Fraud Team component 5.13 may provide services to customers to help them minimize the effects of fraud.

The Account Management component 5.14 may monitor service metrics and ensure that expectations are being met. It may also establish procedures to measure, report, and assess progress. It may further establish governance processes to ensure a structured process for change requests and service modifications. Two levels of service may be recognized: a management level to handle the day-to-day issues, potential risks, and resource identification; and an executive level to handle month-to-month planning, promotions, and helping the business.

The Card Management component 5.15 may provide basic card lifecycle processes, including hotlist and blacklist features. This may allow an MNO or bank to perform card issuance services in-country.

The Client Configuration/Implementation component 5.16 may configuration management to allow for client customization.

6.0 Operations Support

The Financial Management component 6.1 may maintain the financial requirements of the service and may track financial performance of the service staff.

The HR Management component 6.2 may handle typical human resource duties including recruiting, staffing, and retention.

The Business Continuity Management component 6.3 may create a BCP (business continuity planning) to ensure that essential functionality of the service is preserved in the event of a disaster.

The Facilities Management component 6.4 may ensure high performance from the service hardware. This may include records retention, requisitions, maintenance, and storage related to the service. Additionally, it may include escalation point in the event of issues affecting the service.

The Technology Management component 6.5 may manage a stable technology platform to support the operations of the managed service. This may include maintaining relationships with the teams responsible for upkeep of the service.

The Security Management component 6.6 may maintain a set of security requirements documents for the service and may ensure adherence to a security policy, and identify, implement, and monitor the security controls to ensure compliance.

7.0 Service Management

The Incident Management component 7.1 may respond to any incidents involving the service and provide connections to infrastructure, security, and disaster recovery teams in the event of a failure.

The Problem Management component 7.2 may prevent problems or incidents from occurring, reduce the number of resulting incidents by understanding the problem, lessen the effects of incidents that cannot be prevented, and provide the highest levels of service quality.

The Request Management component 7.3 may provide a channel through which users can request and receive predefined services, initiate the request according to predefined business rules, provide guidance to users on SLA (service level agreement), deliver and support requested components, and obtain approval for special requests.

The Change Management component 7.4 may ensure that the proposed changes to any aspect of service under the terms of service are monitored, controlled, and implemented with a minimum of disruption.

The Demand Management component 7.5 may manage the SLA to ensure that service levels are meeting the level of demand for the service. It may coordinate with other change management teams to forecast future demand based on current usage.

The Resource Management component 7.6 may prepare and maintain a resource staffing plan that takes into account current and future requirements. It may ensure that SLAs are met and increase levels of service accordingly and monitor service-related issues.

The User Relationship Management component 7.7 may identify service issues based on user surveys and provide feedback to suggest areas of service improvement. It may measure and enhance user satisfaction of the service.

The Performance Management component 7.8 may provide assurance that defined service levels are being met, identify areas for improvement based on available metrics and service level agreements, and ensure that the service is meeting delivery targets.

8.0 Service Planning

The Service Strategy component 8.1 may build and maintain a strategy and plan to ensure alignment with business needs and strategies and track and communicate plan changes as the needs of the service change.

The Service Introduction component 8.2 may ensure that the service has been developed to meet operational requirements, and that a reasonable SLA is in place. It may determine the required staffing and qualifications required to ensure a smooth implementation.

The Service Decommission component 8.3 may determine the effects of decommissioning the service. It may decommission and perform knowledge transfer of required knowledge and assets.

9.0 Service Delivery Management

The Project, Program, Domain component 9.1 may capture, monitor, and resolve issues. It may build contingency plans for identified risks, coordinate the service domain and effective use of resources, and coordinate delivery of services to end users.

The Capacity Management component 9.2 may measure and re-assess capacity needs by monitoring usage and issues raised based on service performance.

The Release Management component 9.3 may package change requests into releases to avoid small, incremental changes to the platform, prepare the environment for deployment and negotiate required service requests, design and implement procedures for distribution of changes, and manage the release and ensure proper deployment of configuration changes.

The Partner/Supplier component 9.4 may identify, qualify, and select third-party suppliers. It may manage procurement of services, monitor procurement process to evaluate supplier and overall process and track quality and recommend changes as necessary to ensure satisfaction.

The Configuration component 9.5 may define and create a configuration management system to audit and verify configuration items, including versions, components, and relationships. It may maintain baseline configurations to allow for fallback in the event of an issue. It may require authorization for changes to configuration items and ensure protection of items.

The Availability component 9.6 may ensure required availability levels are provided to meet service agreements, optimize capabilities for service delivery, track the client's need and understand infrastructure capabilities for delivering to meet that need.

10.0 Localization

The Localization component 10.1 may provide local localization features to all customer, MNO, issuer, merchant, and agent-facing channels. This may include local currency details and formatting, date/time formatting, and other adjustments not covered by simple language translation.

The Language component 10.2 may provide localized translations of all customer, MNO, issuer, merchant, and agent-facing channels. The predominant languages for each region may be available for selection by the user, and selecting a language may preserve that preference in the user's profile.

11.0 Operations

The NOC (Network Operations Center) component 11.1 provides the personnel, technology, and practices for monitoring services and reacting to issues affecting network stability and security.

The Application Management component 11.2 may provide the necessary personnel and software to manage the service application stack. This includes monitoring, maintenance, upgrades, and integration between the application and existing NOC software. The service may make available personnel to assist the data center in the monitoring and upkeep of the service.

The Infrastructure Management component 11.3 may provide the necessary personnel and software to manage the hardware used by the service in conjunction with other hardware in use. This may include integration of new hardware into the data center, requiring flexible monitoring and network tools to ensure a smooth scaling of resources.

The Reporting component 11.4 may provide the necessary connections to allow for outside network monitoring, application stack status, and troubleshooting.

The Ticket Management component 11.5 may provide a ticket management system capable of handling trouble tickets for issues raised against the service.

The Release Management 11.6 may include a process and toolset for managing new releases and updates to the EE platform including agent notification, certification, QA and testing to minimize disruption to services.

The Hosting component 11.7 may include hosting the managed service in a secure, PCI-compliant data center meeting SAS70 requirements. It may provide the necessary bandwidth and robust connections to ensure low network latency between the data center and the countries/regions for which it is hosting managed services.

The DR & BCM component 11.8 may provide disaster recovery and business continuity management and include the necessary processes and backup procedures to handle network and software outages within the data center. This may include frequent off-site backups, redundant power and AC, and other industry-standard practices to ensure smooth failover to backup servers in the event of trouble.

12.0 Operations Management

The Quality & Compliance component 12.1 may create and manage a quality management strategy to ensure the delivery of quality service that meets stakeholder expectations. It may maintain and update reporting standards and prepare reports.

The Quality & Improvement component 12.2 may measure performance indicators and operating a system to remove systemic problems and improve future performance.

The Knowledge Management component 12.3 may identify and communicate knowledge and best practices throughout the operations staff and publish knowledge to a knowledge asset repository.

13.0 Development

The Release Management component 13.1 may manage new releases and updates to the platform including agent notification, certification, QA and testing to minimize disruption to services.

The Development component 13.2 may manage the system architecture and methodologies, and provide a working knowledge of its functionality.

The Testing component 13.5 may develop or identify testing architecture for robust testing of service platform.

The Maintenance component 13.6 may provide a maintenance plan to handle the ongoing upkeep of the service and its associated applications and ensure a smooth release cycle for upgrades and patches to the system.

14.0 Security

The PCI (payment card industry) component 14.1 may incorporate the service into existing PCI compliance tests and ensure data centers are certified SAS70/PCI compliant.

The SAS70 component 14.2 may ensure SAS70 compliance for personally identifiable information stored on the service.

The HSM & Keys component 14.3 may provide key management support (e.g., through use of a hardware security manage) for authentication and confidentiality. Authentication and confidentiality may be achieved by making use of symmetric and asymmetric ciphers. These ciphers rely on keys that need to be managed and administered.

The SSO (Single Sign-on) component 14.4 allows a customer, agent, or merchant to sign in to the system and maintain a set of credentials for the remainder of the session, regardless of subsystem being accessed through the channel. The service may accommodate single sign-on capabilities, allowing traversal through portal subsystems without further authentication prompts.

The Encryption component 14.5 includes encryption of sensitive PII at all times, and secure key maintenance and storage.

The PII component 14.6 may allow sensitive PII to be stored securely, in an encrypted fashion, and retrieved only when needed for a specific function within an authorized application.

The Authorization/Authentication component 14.7 may provide for secure authentication of users. Hierarchies of access (agent-merchant-customer) may be provided by an authorization system.

The Data Zoning component 14.8 may segregate data collected by applications into security zones, preventing some applications from retrieving data outside of the applicable zone. Sensitive PII may be isolated from all components of the service that do not explicitly require them.

15.0 Off-Platform

The Card Manufacturers component 15.1 may develop a fulfillment relationship with a local card manufacturer, allowing the service to provide plastics, embossing, personalization, fulfillment, and inventory management. It may provide for the ability to instantly issue non-personalized cards, and the ability to issue personalized cards.

The AML/OFAC component 15.2 may provide legal requirements dictating the prevention, detection, and reporting of money-laundering activities.

The VisaNet component 15.3 may build, maintain and certify a connection to VisaNet or other payment processing network. VisaNet or other payment processing network may be available for connection for completion of card routing and processing.

The Risk Management component 15.4 may allow the ability to access intelligence and reports in the open loop and pull them into service to provide insight into risk and exposure.

The GMBS (Billing) component 15.5 may allow integration with the Visa GMBS billing system to handle local processing of transaction data to assemble into a unified feed.

The ROL (Resolve OnLine) component 15.6 (e.g., Visa Resolve OnLine (VROL)) may provide resolution services. For example, Visa Resolve Online is a Visa tool that provides transaction inquiry, exception management, case management, and chargeback automation for card-based services like DPS.

16.0 Integration

The Central Connection Platform 16.1 component may comprise a set of tools for issuing card numbers and provides routing information for VisaNet messaging. It may also provide service routing and orchestration for in-country banking and MNO services.

The Local Gateway Connect component 16.2 may manage a connectivity platform to allow for the Managed Services to integrate with in-country service partners including card fulfillment, bill pay, remittance and air-time top up.

The Channel GW component 16.3 may provide tools to connect to and manage inbound communications channels (e.g., managing USSD/SMSC gateways).

The Portal Access component 16.4 may allow client users to access services via web browser. For example, a MNO or bank may look up customer information and manage the platform.

The Third Party Gateway component 16.5 may provide connectivity into a third-party service for message or transaction processing (e.g., ATM gateway, in-country Bill aggregator service, Top-up providers).

The Interface to Billing component 16.6 may provide the ability to extract key platform information to drive billing systems.

The Network Enabler component 16.7 may enable connections to the USSD mobile operator service and may enable connections to the SMSC gateway mobile operator service.

The Third-Party CRM component 16.8 may provide integration with client CRM systems.

The Lowest Cost Routing 16.9 may determining the lowest-cost routing between closed-platform brand groups, avoiding open-loop processing where possible.

A MMS Service Offering Model according to embodiments of the invention is shown in FIGS. 4A and 4B. Software modules capable of performing the functions described in FIGS. 4A and 4B may be present in the managed service payment platform.

1.0 Channel & Devices

The Mobile Device component 1.01 provides service for mobile devices such as basic phones, feature phones and smart phones. The service may include activating a card or virtual card prior to purchase.

The Web/Other Devices component 1.02 provides service for Web browsers and mobile browsers. The service may be available by home and work PCs, laptops, PC based POS terminals and Wi-Fi enabled tablets. The service may be available via web browser and functionally-specific portals and provide access to mini-statements and other self-service tools.

The Card/vCard component 1.03 provides service for virtual card (vCard), companion card, and acceptance of cards at POS, ATM, etc. The service may include the issuance of physical or virtual cards. For example, a virtual card and (optional) companion card may be issued with a PAN and with a BIN from a sponsoring bank.

The POS Terminal component 1.04 provides service for a Magstripe POS, Mobile Phone POS, and mCommerce terminal. Point of Sale terminals may include traditional magnetic swipe terminals at retailers and mobile Point of Sale (mPOS) terminals running on merchants' mobile phones.

The Payment Application component 1.05 provides a payment application to present menus and options for the service. A menu may be presented on the mobile device. The menu may present basic payment functions such as balance, mini-statement, top-up, bill payment, and other payment functions. A SIM toolkit or Smartphone app may be issued to a bank or mobile operator for customization, or presentation through USSD or IVR menus. This application may allow the customer to authorize an account for vCard transactions over a predefined period.

The service may provide for messaging via an SMS channel for transactions, promotional, and service information messages. An MNO may provide an SMS connection, connection to an SMSC for STK application, or service may be provided by payment processing network (e.g., Visa) appointed aggregator of services. A bank may use a payment processing network aggregator.

The SMS/Messaging component 1.06 may provide for open or encrypted SMS. Unstructured Supplementary Service Data (USSD) may be sent between the handset and the MNO via the signaling channel of the handset and a USSD gateway. These light-weight applications may permit encrypted communication between the customer and the MNO.

The IVR/Callback component 1.08 may provide IVR callback and an automated voice response unit. An IVR infrastructure may provide out-of-band authentication (e.g., PIN verification) or self-service features.

The HTTP/Session component 1.09 may provide basic HTTP/HTTPS/XHTML communication capabilities. Web browsers (PC-based and mobile) and third-party systems may use HTTP, HTTPS, and XHTML to send web service messages in and out of the platform.

The Code/Token component 1.10 may issue codes (e.g., for discounts) and tokens (e.g., one-time passcode) to provide for account-less cash operations, cardless operations at ATMs, and discounts.

The NFC (near-field communication) component 1.11 may provide NFC service to enable devices to exchange encrypted data over a short distance.

2.0 Loyalty & Rewards

The Loyalty/Coupon/Voucher Redemption component 2.01 may provide loyalty and rewards management and redemption. The services around loyalty and rewards may include design, issue, and distribution of coupons and vouchers and integration of these into the payment process and point of sale. The services may further include providing analytics for campaign management and value-added services.

The Coupon/Voucher/Offers/Incentives component 2.02 may support offering incentives to customers to buy goods and services. This may include setting rules related to the incentives, offering coupons and codes, and tacking metrics for an incentive program.

The Promotion Management component 2.03 may provide features for managing promotions, including the value and expiration of coupons/vouchers, regions and brand groups to target, and analytics-backed metrics providing feedback on promotion effectiveness.

The Advertising component 2.04 may provide management of brand-and region-based advertising campaigns, incorporating metrics to provide analytics on promotion success.

The Location Based Services component 2.05 may track a customer's location and use this information to send targeted loyalty advertisements and offer incentives based on that location.

The Loyalty POS Interaction component 2.06 may allow acceptance of loyalty coupons, vouchers, and codes at a POS and may support the use of a combination of cash and loyalty to pay for purchases.

The Loyalty Program component 2.07 may track customer loyalty through analytics to offer rewards to customers achieving a level of loyalty to the service or a particular program.

The Loyalty Management component 2.08 may provide management of a loyalty program, including overall program management and brand- and region-based success metrics. This may include analytics and metrics of loyalty programs, and management of program durations, loyalty coupon benefits, etc.

3.0 Lifecycle Management: Customer

The Customer Acquisition component 3.1.1 may provide data capture, storage, and authentication by a bank or payment processing network. The service may provide configurable features for customer registration to capture essential information required to support KYC and KYA verification, storage, aggregating, archiving of recorded documentation. The service handles ongoing updates and changes to data and management of data. Customers may be acquired onto a set of proportionate services based on their KYC criteria. The service may provide tools to provide a process of capturing client data as a sign up agent.

The Validation and Verification component 3.1.2 may provide activation and division of roles and provide validation and management of customer acquisition materials and KYC.

The Account Management component 3.2.1 may provide tools for web-based management and client account configuration, including setting of products, fees, limits, brand groups, and payment transactions enabled by products for customers.

The Customer Management component 3.2.2 may allocate appropriate accounts to customers and any change of status of customer due to enhanced or degraded KYC information or client offering.

The Activation/Retention component 3.3.2 may provide toolsets to manage the activation and retention of clients. It may provide analytics around customer retention to assist clients by tracking customers likely to close their accounts.

The Load/Unload component 3.2.3 may provide for the movement of cash in and out of the platform. For example, it may provide the ability to load via an agent, via a payment processing network (e.g., VisaNet) and the ability to unload via an agent, ATM, or payment processing network (e.g., Visa) account.

The Bulk Funds In component 3.2.4 may provide the ability to accept bulk cash deposit and distribution to multiple customer/subscriber accounts (e.g. payroll distribution). This process may operate in a batch mode.

Customer Service/Customer Care (Help Desk) component 3.2.5 may be responsible for management, redirection, and resolution of issues. Such functions may be provided in response to a client calling a customer service number on the back of a card or collateral.

The Repair or Cancellation of Services component 3.3.1 may provide for the closure of accounts and subsequent hand-offs and processes associated with the cancellation of services.

The Collection and Recoveries component 3.3.3 may provide for hand-off of processes for return of funds by a client. This may include bank holds funds, account closure and presentment of the final balance remaining, which may be provided back to the consumer at the consumer's address.

3.0 Lifecycle Management: Agent/Merchant

The Agent Acquisition Registration component 3.4.1 may allow the process of on-boarding agents onto the platform to enable them to serve as a service agent, with a float of funds and valid KYC/KYA data to provide additional services to subscribers such as selling top up, executing bill payments, taking cash in, paying cash out and initiating payment transactions with subscribers.

The Merchant Acquisition Registration component 3.4.2 may allow the process of on-boarding a mobile merchant. A mobile merchant may be an identified individual, with a mobile phone who has signed up as a mobile merchant, with an account in a bank (for settlement out) and valid KYC/KYA data. A mobile merchant may be able to initiate and complete p2p (person to person) like payments with subscribers.

The mPOS/POS Deployment component 3.4.3 may allow closed-loop transactions and open-loop transactions, accept MSISDNs, accept PANs, and accept PAN for all cards (entry to mPOS). The platform may provide for deployment of a mobile POS infrastructure and a mobile handset as mobile point of sale.

The POS Certification component 3.4.4 may allow Mobile POS handsets for card acceptance to be certified by payment processing network (e.g., Visa).

The Agent Certification component 3.4.5 may support issuing of a common identifier (scheme mark) for closed-loop payments. This may aid in the identification of accepting agents.

The Retail Merchant Certification component 3.4.6 may allow for a closed loop scheme and an open loop scheme. A certifying mark provides visual cues that the merchant is able to process a payment on the system.

The Merchant Management component 3.5.1 may provide tools for management of agent care (hierarchies, fees, commissions, settlement, locations).

The Merchant Care component 3.5.2 may provide (Help Desk) Level 1 support, level 2/3 support, ticket opening/management tool, closed-loop merchants, open-loop merchants, and unified merchant management portal. The service may provide features for inbound merchant inquiries and issues.

The Agent Management component 3.5.3 may provide for associating different service products to merchants and agents, and enabling/disabling certain features based on their KYA profile and contract terms.

The Merchant Marketing component 3.5.4 may provide merchant marketing services. This may be tied in with the Loyalty/Rewards issuing/acceptance service.

The Load/Unload component 3.5.5 may provide for loading and unloading of funds. This provides the ability to manage the cash in/out and decreasing cash positions to maintain stability.

The Merchant/Agent Closure Repair or cancellation of services, collections and recoveries component 3.6.1 allows for handling the closure of accounts, recovery of funds, and retention of merchants/agents.

4.0 Transaction: Customer

The Payment Processing component 4.1.01 may allow closed loop and open loop scheme payment to be processed on the platform or via a payment processing network such as VisaNet for off-platform processing involving third parties. This allows for transaction management and money movement between systems. Processing of closed-loop transactions may be handled by the platform. Open-loop transactions handled by third-parties may be routed through a payment processing network such as VisaNet.

The Fraud/Security component 4.1.02 may include fraud mitigation and monitoring features. The service may provide fraud monitoring characteristics and alerting to identify potentially fraudulent transactions.

The Data Protection/Privacy component 4.1.03 component may allow for data to be stored within a payment processing network's (e.g., Visa's) secured systems, protecting personally identifiable information to conform with published data protection policies. For example, the storage and protection of PII (personally identifiable information) for customers and accounts to regulations and certifications require encryption and secure processes to be in place.

The Payment Authorization component 4.1.04 may allow for a customer to enter a passcode to perform financial transactions and to unlock the card for a transaction. The payment processing network (e.g., VISA) may hold journal entry for balance and rules.

The Risk Management component 4.1.05 may provide functionality to track and manage risk.

The Reversal component 4.1.06 may provide tools for a financial admin to reverse a transaction. For example, after a transaction has been completed, the agent/merchant has the ability to reverse the transaction, moving funds back to the customer.

The Clearing and Settlement component 4.2.01 may provide for toolsets to identify settlement positions for third-parties, agents, merchants, and external financial agencies, allowing for clearing and settlement (e.g., at end-of-day). The service may provide single point settlement including managing the end-of-day cut-off for VisaNet, local Debit/ATM networks, closed loop networks, billers, airtime top-up partners, remittance partners, settlement reporting and movement of money between all parties.

The Invoicing/Statements component 4.2.02 may provide for invoicing of third parties based on defined usage of services.

The Transaction Analytics component 4.2.03 may monitor all closed-loop and open-loop (e.g., VisaNet) transactions to provide consolidated dataset for analytics for profitability management.

The Reconciliation component 4.2.04 may provide tools for auditing transactions and reconciling individual accounts and positions. This includes the ability to provide summary reports to identify position and accounts for settlement and balancing.

The Audit/Reporting component 4.2.05 may provide tools for transaction, account, and access-level auditing and generation of a standardized set of reports to support the financial management of the platform. This may include providing detailed daily, weekly, monthly reports and data warehouse services for ad-hoc reporting for customers (MNO's and Issuers) and agents. Reports may include detailed and summary level reports.

The Chargeback/Reversals/Disputes component 4.2.06 may manage chargebacks, reversals and disputes.

4.0 Transaction: Merchant/Agent

The Merchant Payment Authorization component 4.3.01 may provide for agent- or merchant-initiated payments or transactions, following PIN entry, producing a message to the consumer requesting authorization (if authorized by the customer, the payment is completed).

The Merchant Processing/Transmission component 4.3.02 may provide connectivity for agents and merchants to complete transactions. The service may provide connectivity for agents via mobile phones and merchants via mobile phones and traditional POS terminals (over ISO8583) for completion of transactions against the platform.

The Agent/Merchant Reversals component 4.3.03 may provide tools for a financial admin to reverse a transaction. For example, after a transaction has been completed, the agent/merchant may have the ability to reverse the transaction, moving funds back to the customer.

The Merchant Clearing and Settlement component 4.4.01 may provide tools for the identification of settlement position and funds for movement. Settled funds may be transferred out of the platform to the merchant's designated bank account (e.g., at end-of-day or by arrangement). The service may provide single point settlement including managing the end-of-day cut-off for payment processing network such as VisaNet, local Debit/ATM networks, closed loop networks, billers, airtime top-up partners, remittance partners, settlement reporting and movement of money between all parties.

The Merchant Liability Management component 4.4.02 may provide management of merchant settlement terms and conditions to clearly define merchant limits of liability.

The Merchant Chargeback/Disputes component 4.4.03 may provide a toolset for merchant chargeback and dispute resolution. This may include receiving incoming calls from the consumer or agent, managing provisional credit, research and final resolution of the disputes and chargebacks for transactions between mobile money cardholders and agents/merchants and P2P transactions. Possible sources of dispute include: Cash In, Cash Out, ATM, P2P Fund Transfer, Purchase, Bill Pay, and Airtime Top Up.

5.0 Service Enablement

The Wallet Setup and Registration component 5.01 may provide the high level processes for setting up a wallet.

The Payment Account Setup component 5.02 may provide the high level process for setting up payment products on the platform.

The Mobile Banking Activation component 5.03 may provide the functionality of connecting a bank to the platform for mobile banking services.

The Mobile Payment Application component 5.04 may support the management of the mobile application development and issue. The platform may support the manual mapping of PAN to MSISDN.

The Card/vCard Issuance component 5.05 may include generating and allocating PANs to MSISDN Wallet accounts (using CCP).

The Regulatory/Governance component 5.06 may meet mandatory government and country requirements.

The Device Enablement (MFF) component 5.07 may support multiple mobile phone devices for clients as an outsourced task supporting multiple form factors (MFF). This may include application/SIM Toolkit for a range of devices, device testing, certification, and refresh of the mobile application as handset or conditions change.

The POS/mPOS Enablement component 5.08 may support a point of sale network.

6.0 Payment Processing Network to Customer Offering Management

The Payments Core Processing component 6.01 may provide a processing platform.

The Sales/Contract Management component 6.02 may establish a member onto the platform and service ongoing requirements.

The Product/Service Management component 6.03 may support options of offerings and combinations laid out above, and client management. The platform may support the ability for multiple products and instances as required by regulations.

The Integration/Maintenance component 6.04 may support external connections by providing documentation and tools for third-party development. This may include providing an interface to support connections with 3rd parties and maintenance of the connections due to 3rd party side changes. Support may include provisioning credentials, endpoint management, development of standard APIs and service descriptions.

The Endpoint Management component may provide endpoint management and termination of secure connections within the platform.

The Client Management component 6.05 may provide functionality for basic client management. Tied to sales and contract information, this may include identification of the member, an explanation of services, billing details, and expiration information.

The Loyalty Management component 6.06 may include the ability to construct and run loyalty campaigns from the service, engaging merchants and customers, and spending of loyalty.

The Fraud/Security Systems component 6.07 may include standard RiskSecure/AML fraud systems on-platform.

The Data Acquisition component 6.08 may include getting and processing of client data uploads (e.g., using VFES to load a batch file for payroll distribution to wallets).

The Data Management component 6.09 may provide secure storage and secure archival. This may include the encryption, cleaning and secure archiving of data on the platform and off platform as it ages.

The Analytics component 6.10 may include an analytics package to help clients and merchants understand platform effects and trends.

7.0 Organizational

The Strategy/Product Management component 7.01 may provide a high level plan for the platform, blueprint and evolution consistent with budget setting and yearly operations.

The Risk & Regulatory component 7.02 may provide support for risk and regulatory compliance.

The Finance & Accounting component 7.03 may provide the financial and accounting functions for the platform beyond clearing and settling to the TCO and P&L presentation.

The Legal & Compliance component 7.04 may provide supporting member engagement and country deployment to standards.

The Marketing component 7.05 may provide platform marketing support.

The HR & Administration component 7.06 may maintain staffing and skills for people working on the platform in all roles, and for 24/7 operations support.

8.0. Ongoing Regulatory & Governance

The Ongoing Regulatory & Governance component may provide tools and processes to support regulatory compliance (reporting, audit and data storage) and platform governance (audit, separation of roles and balance accounting to standards).

Exemplary Computer System

The various participants and elements (e.g., the payment processing network, the originating user 10, the non-originating user 14, the mobile payment system 30 (including the process orchestrator 32 and managed service payment platform 34), other entities, etc.) in embodiments of the invention may also operate one or more computer apparatuses (e.g., a server computer) to facilitate the functions described herein. Any of the elements in embodiments of the invention may use any suitable number of subsystems to facilitate the functions described herein. Examples of such subsystems or components are shown in FIG. 7. FIG. 7 illustrates an exemplary computer system 300, in which various embodiments may be implemented. The system 300 may be used to implement any of the computer systems described above (e.g., merchant computer apparatus, acquirer server, issuer server, payment processing server, mobile device, access device, etc.). The computer system 300 is shown comprising hardware elements that may be electrically coupled via a bus 324. The hardware elements may include one or more central processing units (CPUs) 302, one or more input devices 304 (e.g., a mouse, a keyboard, touchpad, etc.), and one or more output devices 306 (e.g., a display device, a printer, etc.). The computer system 300 may also include one or more storage devices 308. By way of example, the storage device(s) 308 may include devices such as disk drives, optical storage devices, solid-state storage device such as a random access memory (“RAM”) and/or a read-only memory (“ROM”), which may be programmable, flash-updateable and/or the like.

The computer system 300 may additionally include a computer-readable storage media reader 312, a communications system 314 (e.g., a modem, a network card (wireless or wired), an infra-red communication device, etc.), and working memory 318, which may include RAM and ROM devices as described above. In some embodiments, the computer system 300 may also include a processing acceleration unit 316, which may include a digital signal processor DSP, a special-purpose processor, and/or the like.

The computer-readable storage media reader 312 may further be connected to a computer-readable storage medium 310, together (and, optionally, in combination with storage device(s) 308) comprehensively representing remote, local, fixed, and/or removable storage devices plus storage media for temporarily and/or more permanently containing, storing, transmitting, and retrieving computer-readable information. The communications system 314 may permit data to be exchanged with the network and/or any other computer described above with respect to the system 300.

The computer system 300 may also comprise software elements, shown as being currently located within a working memory 318, including an operating system 320 and/or other code 322, such as an application program (which may be a client application, Web browser, mid-tier application, RDBMS, etc.). It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, may include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which may be used to store or transmit the desired information and which may be accessed by the computer. Based on the disclosure and teachings provided herein, a person of ordinary skill in the art may appreciate other ways and/or methods to implement the various embodiments.

It should be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

Embodiments of the invention may be used with system such as those described in Application No. 61/526,555 and Application No. 61/526,666. All patents, patent applications, publications, and descriptions mentioned above are herein incorporated by reference in their entirety for all purposes. None is admitted to be prior art.

What is claimed is:

1. A method comprising:
receiving, at a mobile payment system, transaction information from a mobile device operated by an originating user;
generating, by the mobile payment system, a transaction request message using the transaction information from the mobile device operated by the originating user;
analyzing, by the mobile payment system, the transaction request message to determine a type of the transaction; and
processing, by the mobile payment system, the transaction based on the type of the transaction;
wherein the mobile payment system is configured to integrate at least two of an issuer, acquirer, and payment processing network functional modules.

2. The method of claim 1 wherein determining a type of the transaction comprises determining whether the transaction is a closed loop or open loop transaction.

3. The method of claim 2 further comprising:
based on the determination that the transaction is a closed loop transaction, determining an account to be used to fund the transaction;
analyzing the account to determine whether there are sufficient funds to cover the transaction;
authorizing the transaction based on the determination that there are sufficient funds to cover the transaction; and
denying the transaction based on the determination that there are not sufficient funds to cover the transaction.

4. The method of claim 3 wherein determining an account to be used to fund the transaction is based on information included in the transaction request message.

5. The method of claim 2 further comprising:
sending the transaction request message to a payment processing network based on the determination that the transaction is an open loop transaction;
receiving the transaction request message back from the payment processing network;
determining whether there are sufficient funds to cover the transaction; and
sending an authorization response message to the payment processing network.

6. The method of claim 1 further comprising:
sending a notification message to the originating user indicating whether or not the transaction was authorized.

7. The method of claim 2 wherein the transaction request message relates to a transaction between the originating user and a non-originating user of a mobile device using a first account associated with the originating user and a second account associated with the non-originating user,
and wherein determining whether the transaction is a closed loop transaction comprises determining that the first account and the second account are associated with the same financial entity.

8. The method of claim 2 wherein the transaction request message relates to a transaction between the originating user and a non-originating user of a mobile device using a first account associated with the originating user and a second account associated with the non-originating user,
and wherein determining whether the transaction is an open loop transaction comprises determining that the first account is associated with a different financial entity than the second account.

9. The method of claim 8 wherein the financial entity includes a bank or a Mobile Network Operator (MNO).

10. The method of claim 1 further comprising:
determining fees associated with the transaction.

11. The method of claim 1 further comprising:
determining a channel through which the transaction information was received.

12. The method of claim 11 further comprising:
determining whether the channel is an authorized channel; and
denying the transaction based on the determination that the channel is not an authorized channel.

13. The method of claim 1 wherein the issuer functional module comprises at least one of a card management functionality, authorization and settlement functionality, enrollment and issuance functionality, and funding and fee management functionality.

14. The method of claim 1 wherein the acquirer functional module comprises a process for processing transactions for merchants and agents associated with the mobile payment system and merchants and agents not associated with the mobile payment system.

15. A server computer comprising:
a processor; and
a computer readable medium coupled with the processor, the computer readable medium comprising computer readable program code embodied therein, the computer readable program code adapted to be executed by the processor to
receive, at a mobile payment system, transaction information from a mobile device operated by an originating user;
generate a transaction request message using the transaction information from the mobile device operated by the originating user;
analyze the transaction request message to determine a type of the transaction; and
process the transaction based on the type of the transaction;
wherein the mobile payment system is configured to integrate at least two of an issuer, acquirer, and payment processing network functional modules.

16. The server computer of claim 15 wherein determining a type of the transaction comprises determining whether the transaction is a closed loop or open loop transaction.

17. The server computer of claim 16 wherein the computer readable program code is further adapted to be executed by the processor to:
based on the determination that the transaction is a closed loop transaction, determine an account to be used to fund the transaction;
analyze the account to determine whether there are sufficient funds to cover the transaction;
authorize the transaction based on the determination that there are sufficient funds to cover the transaction; and
deny the transaction based on the determination that there are not sufficient funds to cover the transaction.

18. The server computer of claim 17 wherein determining an account to be used to fund the transaction is based on information included in the transaction request message.

19. The server computer of claim 16 wherein the computer readable program code is further adapted to be executed by the processor to:
send the transaction request message to a payment processing network based on the determination that the transaction is an open loop transaction;
receive the transaction request message back from the payment processing network;
determine whether there are sufficient funds to cover the transaction; and
send an authorization response message to the payment processing network.

20. The server computer of claim 15 wherein the computer readable program code is further adapted to be executed by the processor to:
send a notification message to the originating user indicating whether or not the transaction was authorized.

21. The server computer of claim 16 wherein the transaction request message relates to a transaction between the originating user and a non-originating user of a mobile device using a first account associated with the originating user and a second account associated with the non-originating user,
and wherein determining whether the transaction is a closed loop transaction comprises determining that the first account and the second account are associated with the same financial entity.

22. The server computer of claim 16 wherein the transaction request message relates to a transaction between the originating user and a non-originating user of a mobile device using a first account associated with the originating user and a second account associated with the non-originating user,
and wherein determining whether the transaction is an open loop transaction comprises determining that the first account is associated with a different financial entity than the second account.

23. The method of claim 21 wherein the financial entity includes a bank or a Mobile Network Operator (MNO).

24. The server computer of claim 15 wherein the computer readable program code is further adapted to be executed by the processor to:
determine fees associated with the transaction.

25. The server computer of claim 15 wherein the computer readable program code is further adapted to be executed by the processor to:
determine a channel through which the transaction request message was received.

26. The server computer of claim 25 wherein the computer readable program code is further adapted to be executed by the processor to:
determine whether the channel is an authorized channel; and
deny the transaction based on the determination that the channel is not an authorized channel.

27. The server computer of claim 15 wherein the issuer functional module comprises at least one of a card management functionality, authorization and settlement functionality, enrollment and issuance functionality, and funding and fee management functionality.

28. The server computer of claim 15 wherein the acquirer functional module comprises a process for processing transactions for merchants and agents associated with the mobile payment system and merchants and agents not associated with the mobile payment system.

29. A method comprising:
receiving transaction information from a device operated by an originating user though a communication channel;
determining that the communication channel is an authorized channel for a financial institution associated with the originating user;
generating a transaction request message using the transaction information received from the device operated by the originating user;
analyzing the transaction request message to determine a type of the transaction; and
routing the transaction request message for transaction processing based on the determination of the type of the transaction.

30. The method of claim 29 further comprising:
determining whether the transaction is an open loop or a closed loop transaction, and routing the transaction to an external payment processing network if the transaction is an open loop transaction.

31. The method of claim 29 wherein receiving, determining, generating, analyzing, and routing are performed by an orchestrator in a mobile payment system.

32. A computer comprising code executable by a processor, for implementing a method comprising:
receiving transaction information from a device operated by an originating user though a communication channel;
determining that the communication channel is an authorized channel for a financial institution associated with the originating user;
generating a transaction request message using the transaction information received from the device operated by the originating user;
analyzing the transaction request message to determine a type of the transaction; and
routing the transaction request message for transaction processing based on the determination of the type of the transaction.

33. The computer of claim 32 wherein the method further comprises:
determining of the transaction is an open loop or a closed loop transaction, and routing the transaction to an external payment processing network if the transaction is an open loop transaction.
